(19) United States
(12) Patent Application Publication
(10) Pub. No.: US 2016/0335899 A1
(43) Pub. Date: Nov. 17, 2016

(54) Terminal Area Alert System

(71) Applicant: The Boeing Company, Chicago, IL (US)

(72) Inventors: Samantha A. Schwartz, Castle Pines, CO (US); Andreas Sindlinger, Wienheim (DE)

(21) Appl. No.: 14/709,890

(22) Filed: May 12, 2015

(51) Int. Cl. G08G 5/00; G08G 5/04

(52) U.S. Cl. CPC G08G 5/0013; G08G 5/0026; G08G 5/0039; G08G 5/04

(57) ABSTRACT

A method and system for handling a missed approach of an aircraft. A group of signals that indicates a go-around maneuver occurring during an approach of the aircraft to land at an airport is detected on a data bus in the aircraft. An alert to an air traffic control system for the airport when the signal is detected. The alert indicates an occurrence of the go-around maneuver, enabling rerouting of air traffic in a manner that enhances safety.

### BACKGROUND INFORMATION

1. Field:

The present disclosure relates generally to aircraft and, in particular, to information about the operations of the aircraft. Still more particularly, the present disclosure relates to a method and apparatus for generating alerts when abnormal flight procedures occur within a terminal area of an airport.

2. Background:

Pilots perform various tasks when operating an aircraft. For example, the pilots fly the aircraft, navigate the aircraft, and communicate with air traffic controllers. Pilots are taught to perform these actions in that order.

For example, when an aircraft is cleared for landing, the pilot may determine that the conditions are not suitable for landing at the airport. For example, the passenger aircraft may not be at a desired altitude, have a desired air speed, or some other factor may not be present to provide landing as safely or with as much comfort to the passengers as desired.

In this situation, the pilot may press a takeoff-go-around (TOGA) button in the cockpit of the aircraft and fly the aircraft in a manner that aborts the approach for the landing. The pilot initiates a missed approach procedure to put the aircraft on a path around the airport until the aircraft is again cleared for another approach for landing.

Thereafter, the pilot initiates communication with the air traffic controller. The pilot communicates the missed approach to the air traffic controller.

The traffic controller then provides the pilot with additional directions. Additionally, the air traffic controller also may reroute other aircraft in the area in response to the missed approach.

With this situation, the time from when the pilot pushes the takeoff-go-around (TOGA) button to the communication with the air traffic controller may be, for example, five seconds, three seconds, or one minute. The pilot may need to perform other tasks in addition to pressing the takeoff-go-around (TOGA) button as part of aborting the approach before communicating with the air traffic controller. The timely communication of this information to the air traffic controller is important in potentially rerouting aircraft that may be flying within the terminal area of the airport.

The radar and other sensor systems at the airport provide information to the air traffic controller about the different aircraft operating in the terminal area of the airport. The air traffic controller may be able to identify when a missed approach occurs even without a communication from the pilot.

However, the air traffic controller often focuses on other aircraft after clearance for an approach for landing has been given. As a result, the air traffic controller often relies on the pilot for information about a missed approach for landing.

Thus, it is desirable for the pilot to be able to communicate this situation to the air traffic controller as soon as possible. However, the priority for the pilot is to aviate then navigate the aircraft to maintain a desired level of safety for the aircraft and then communicate that the aircraft will miss or has missed an approach for landing.

Furthermore, larger airports often have intersecting runways. With this type of configuration of runways, a missed approach may result in the air traffic controller changing takeoff clearances or other landing clearances for other aircraft. As a result, obtaining a communication about a missed approach as quickly as possible is desirable to increase the safety margins for aircraft operating at the airport.

Therefore, it would be desirable to have a method and apparatus that take into account at least some of the issues discussed above, as well as other possible issues. For example, it would be desirable to have a method and apparatus that solve a technical problem with providing information about abnormal flight procedures occurring within a terminal area of an airport quickly enough to enable operations to increase safety in the terminal area.

### SUMMARY

An embodiment of the present disclosure provides a system for reporting a missed approach by an aircraft. The system comprises a communications interface and a computer system. The communications interface is to a data bus in the aircraft. The computer system is in communication with the communications interface. The computer system operates to detect a group of signals on the data bus that indicates a go-around maneuver occurring during an approach of the aircraft to land at an airport, and sends an alert to an air traffic control system for the airport when the group of signals is detected. The alert indicates an occurrence of the go-around maneuver, enabling rerouting of air traffic in a manner that enhances safety.

Another embodiment of the present disclosure provides a computer system for an aircraft. The computer system detects a group of signals in the aircraft indicating an abnormal flight procedure occurring during flight of the aircraft within a terminal area of an airport and sends an alert to an air traffic control system for the airport indicating an occurrence of the abnormal flight procedure, enabling an action that enhances safety.

Yet another embodiment of the present disclosure provides a method for handling a missed approach of an aircraft. A group of signals that indicates a go-around maneuver occurring during an approach of the aircraft to land at an airport is detected on a data bus in the aircraft. An alert to an air traffic control system for the airport when the group of signals is detected. The alert indicates an occurrence of the go-around maneuver, enabling rerouting of air traffic in a manner that enhances safety.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an airport environment in accordance with an illustrative embodiment;

FIG. 2 is an illustration of a block diagram of an airport environment in accordance with an illustrative embodiment;

FIG. 3 is an illustration of a block diagram of an alert in accordance with an illustrative embodiment;

FIG. 4 is an illustration of a flowchart of a process for handling the occurrence of an abnormal procedure in accordance with an illustrative embodiment;

FIG. 5 is an illustration of a flowchart of a process for reporting a missed approach in accordance with an illustrative embodiment; and

FIG. 6 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that the current sequence of aviate, navigate, then communicate, in that order, may not provide information to an air traffic controller as quickly as desired to enhance safety as much as desired. Thus, the illustrative embodiments provide a method and apparatus that generate an alert of a missed approach or other abnormal flight procedure that may occur when aircraft fly within the airspace for an airport.

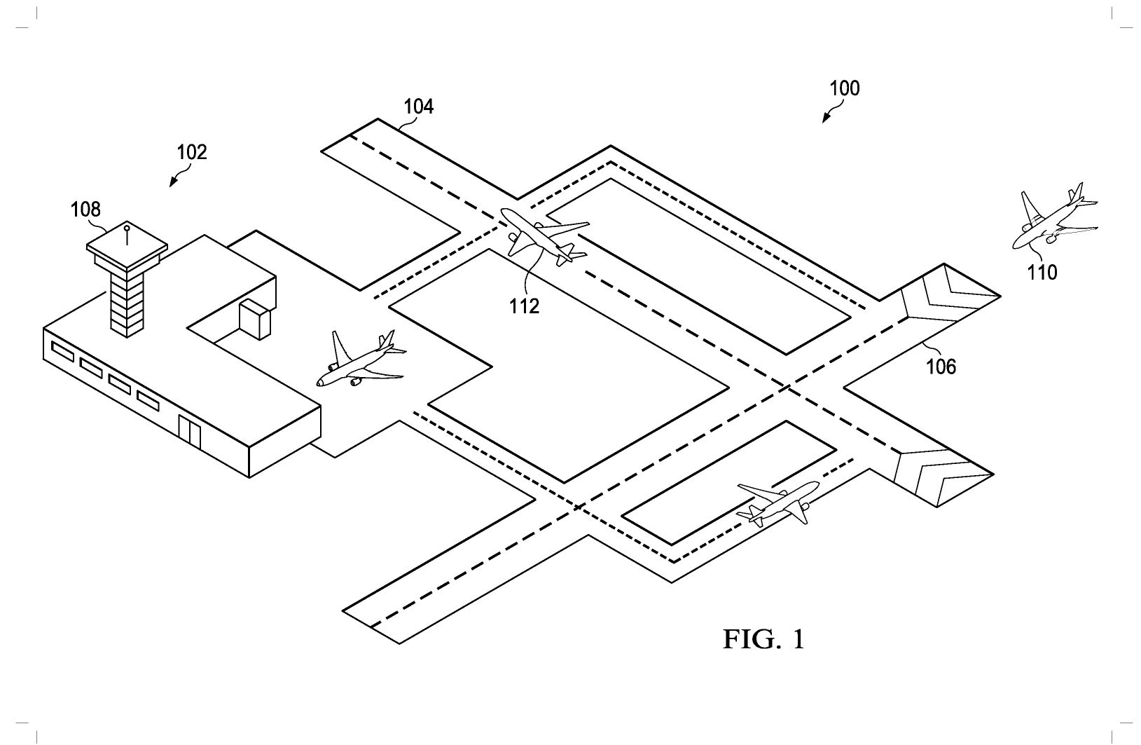

With reference now to the figures and, in particular, with reference to FIG. 1, an illustration of an airport environment is depicted in accordance with an illustrative embodiment. In this illustrative example, airport environment 100 is an example of an environment in which an illustrative embodiment may be implemented.

As depicted, aircraft may take off and land at airport 102. In this illustrative example, runway 104 and runway 106 are shown for airport 102. These runways are used by aircraft for landings and takeoffs at airport 102.

Air traffic control tower 108 is a location where air traffic control systems and air traffic controllers are located. Air traffic controllers are people who manage the movement of aircraft around airport 102. For example, air traffic controllers may give clearances for takeoffs and landings to aircraft at airport 102.

In this illustrative example, aircraft 110 is on a path approaching airport 102 for landing on runway 104. If the pilot is unable to land aircraft 110 on runway 104 on the approach to runway 104, the pilot pushes a takeoff-go-around button in the cockpit of aircraft 110 and flies aircraft 110 off of the path of the approach for landing. The pilot may then navigate the aircraft along a predetermined route for the go-around maneuver after missing the approach.

In the illustrative example, a computer system in aircraft 110 sends an alert to an air traffic control system in air traffic control tower 108. This alert is sent when the takeoff-go-around button in aircraft 110 is pressed by the pilot. This alert reports the missed approach to the air traffic control system.

In turn, the air traffic controller may view or hear the alert presented by the traffic control system. In this manner, a traffic controller is made aware of the missed approach by aircraft 110 sooner as compared to currently used procedures in which the pilot communicates with the air traffic controller to report the missed approach.

With current procedures, the pilot flies aircraft 110 to miss the approach for landing on runway 104, then identifies navigation for a route, and finally, communicates with the air traffic controller. With the computer system in the aircraft sending the alert when the takeoff-go-around button is pushed, the air traffic controller may be made aware of the missed approach much sooner. For example, the alert may occur substantially immediately rather than five seconds, 30 seconds, a minute, or some other period of time at which the pilot contacts and communicates with the air traffic controller under the current procedures.

With the ability to provide an alert to an air traffic controller of the missed approach sooner, the air traffic controller has more time to perform actions that enhance safety. For example, the air traffic controller may cancel clearance of a takeoff by aircraft 112 on runway 106. In other illustrative examples, the air traffic controller may reroute other aircraft that may be clear to approach and land at airport 102. These and other actions may be performed by the air traffic controller much sooner by receiving the alert as compared to current procedures for communicating missed approaches.

The illustration of airport environment 100 is provided as an example of one environment in which an illustrative embodiment may be implemented. This illustration is not meant to limit the manner in which other illustrative embodiments may be implemented.

For example, another illustrative embodiment may provide alerts for takeoffs of aircraft in which the normal procedure for the takeoff is not followed. If an aircraft takes off and is unable to follow the desired route path for a takeoff from airport 102, a computer system in the aircraft sends an alert to an air traffic control system in air traffic control tower 108. In this manner, safety may be enhanced at airport 102 for both takeoffs and landings that occur at airport 102.

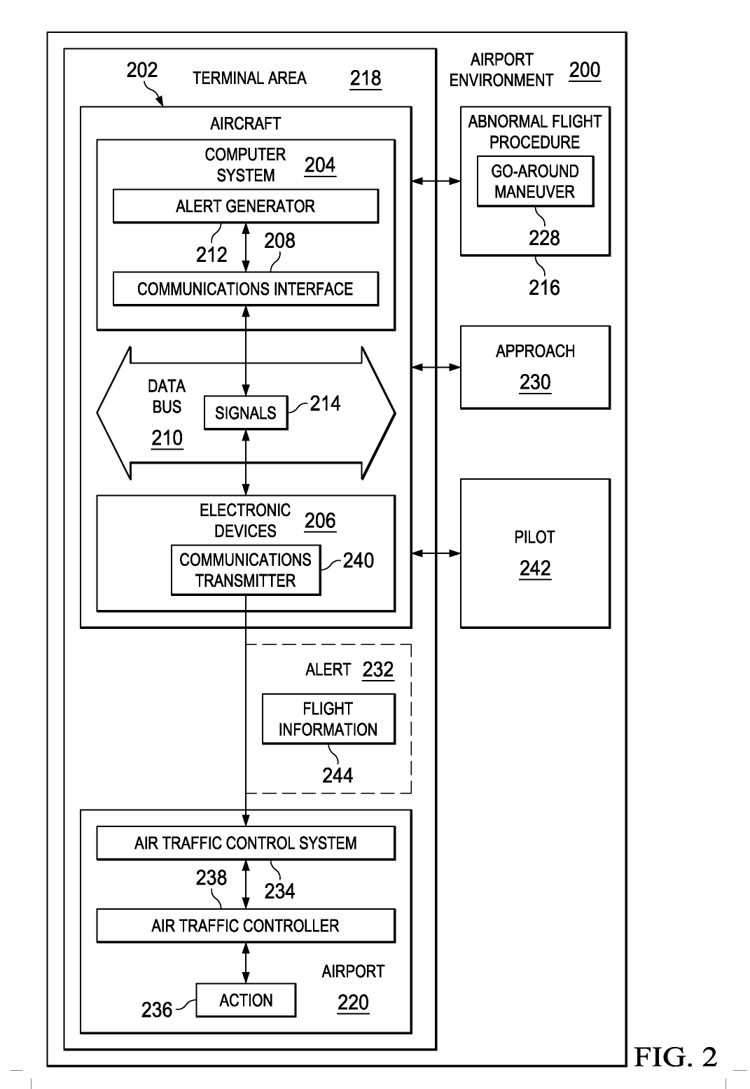

With reference now to FIG. 2, an illustration of a block diagram of an airport environment is depicted in accordance with an illustrative embodiment. In this illustrative example, airport environment 100 in FIG. 1 is an example of one implementation for airport environment 200 shown in block form in this figure.

In this illustrative example, aircraft 202 includes computer system 204. Computer system 204 is a hardware system and includes one or more data processing systems. When more than one data processing system is present in computer system 204, those data processing systems may be in communication with each other through communications media, such as a network.

A data processing system in computer system 204 may be selected from a computer, a flight management system, an electronic flight bag (EFB), a tablet computer, a mobile phone, a laptop computer, or some other suitable device. In one illustrative example, computer system 204 may include a flight management system in the avionics of aircraft 202.

In this illustrative example, electronic devices 206 are also present in aircraft 202. Computer system 204 may communicate with electronic devices 206 through communications interface 208 for computer system 204 to data bus 210.

Electronic devices 206 are physical devices that perform functions in aircraft 202 and communicate using electrical signals. Electronic devices 206 may take various forms. For example, electronic devices 206 may be selected from at least one of a computer system, an avionics system, a router, a switch, a controller, a sensor, a control switch, a button, or other suitable type of electronic device.

As used herein, the phrase “at least one of,” when used with a list of items, means different combinations of one or more of the listed items may be used and only one of each item in the list may be needed. In other words, “at least one of” means any combination of items and number of items may be used from the list but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In this illustrative example, data bus 210 is a hardware system that facilitates communications between different components in aircraft 202, such as computer system 204 and electronic devices 206. Data bus 210 may be implemented using various standards such as, for example, ARINC 429, ARINC 664, MIL-STD-1553, or some other suitable standard.

As depicted, alert generator 212 may be implemented in computer system 204. Alert generator 212 in computer system 204 is a hardware device connected to data bus 210 on aircraft 202, which includes communications interface 208 configured to be connected to data bus 210 on aircraft 202. When communications interface 208 is connected to data bus 210, alert generator 212 monitors information communicated on communications interface 208, which may indicate the presence of an abnormal flight. This information may include, for example, data pertaining to at least one of aircraft commands, controls, or other information of interest.

In this illustrative example, alert generator 212 in computer system 204 detects a group of signals 214 in aircraft 202. As depicted, the group of signals 214 may be generated by one of electronic devices 206. The group of signals 214 is detected on data bus 210 by alert generator 212 through communications interface 208.

As used herein, a “group of,” when used with reference to an item, means one or more items. For example, a “group of signals 214” is one or more of signals 214.

In this particular example, the group of signals 214 may take various forms. The group of signals 214 may be selected from at least one of a voltage level, a message, sensor data, a response to a command, a command, or some other suitable type of information that may be transmitted on data bus 210 by electronic devices 206.

As depicted, the group of signals 214 on data bus 210 may indicate different types of information. For example, the group of signals 214 may indicate at least one of an initiation of a go-around maneuver, a change in altitude indicating a go-around maneuver, a command to increase engine power for a go-around maneuver, an increase in engine power indicative of a go-around maneuver, a deviation from a landing pattern, a deviation from the takeoff pattern, a depression of the takeoff-go-around button, a retraction of the landing gear during approach, or other suitable information.

As depicted, the group of signals 214 indicates abnormal flight procedure 216 occurring during the flight of aircraft 202 within terminal area 218 of airport 220. A flight procedure is a plan of operations that aircraft 202 follows in terminal area 218 of airport 220. The operations may dictate at least one of a path, an altitude, an airspeed, a flap configuration, or other parameters for aircraft 202.

Abnormal flight procedure 216 is a change in the flight of aircraft 202 that deviates from the manner in which aircraft 202 normally flies for a selected flight procedure that aircraft 202 is supposed to perform. The deviation is one that is great enough that aircraft 202 is no longer considered to be performing the selected flight procedure.

For example, abnormal flight procedure 216 may be a preset procedure for terminal area 218, or may be a procedure created by the pilot of aircraft 202 when deciding to miss the approach to maintain a desired level of safety. Abnormal flight procedure 216 may be any procedure that is performed for aircraft 202 when approach 230 for landing will be missed or aborted. Abnormal flight procedure 216 also may include the instance in which aircraft 202 touches down and then takes off again without taxing off the runway. This type of procedure may occur when an obstacle is seen on the runway.

For example, abnormal flight procedure 216 may be go-around maneuver 228 for a missed approach. As depicted, go-around maneuver 228 is a maneuver in which aircraft 202 discontinues landing. After aborting the landing, aircraft 202, for example, may move into a traffic pattern and wait for permission for another approach to land, fly to an alternate airport, or perform some other procedure.

As depicted, go-around maneuver 228 is a deviation from a path for a landing procedure used for an approach and landing on a runway. At some point, the deviation from the path set for the approach in the landing procedure may be greater than a threshold value for a parameter indicating that the approach has been missed. The parameter may be selected from one of a value for a path, an altitude, airspeed, a flap configuration, or other parameter for aircraft 202.

For example, the altitude and crossing the “Inner Marker” that is part of an instrument flight rules (IFR) approach and at least one of the throttles advanced, or starting to retract the landing gear, and pulling flaps are parameters that indicate a missed approach will occur. As another illustrative example, the threshold value could be an increase in airspeed above a recommended maximum approach/landing airspeed for a given aircraft, such as, for example, a value of 160 Knots Indicated Air Speed (KIAS). As another illustrative example, the parameter may be detecting the pressing of a takeoff-go-around button during the short final of the approach for landing indicating a missed approach will occur.

In the illustrative example, the deviation may be a lateral deviation with respect to a top-down view of the route, an altitude, or some combination thereof. Abnormal flight procedure 216 also may be present when the airspeed of the aircraft deviates from a desired airspeed for the flight procedure. As another example, abnormal flight procedure 216 may also be present with the occurrence of at least one of advancing of the throttle that is more than expected for landing, an increase in speed that is more than expected for landing, taking the flaps up during the approach, or retracting the landing gear during the approach.

In this illustrative example, terminal area 218 is the airspace around airport 220. For example, the volume encompassed by terminal area 218 is one in which flight procedures occur for airport 220.

These flight procedures include those for takeoffs and landings. For example, the procedures for landings may include the approach as well as the actual landing of the aircraft. An example of another flight procedure in terminal area 218 is an initial climb.

In one illustrative example, the group of signals 214 indicates go-around maneuver 228 occurring during approach 230 of aircraft 202 to airport 220. In the illustrative example, the approach may be the flight of aircraft 202 along a path towards a runway up to the point where aircraft 202 lands on the runway.

Alert generator 212 sends alert 232 to air traffic control system 234 for airport 220 indicating an occurrence of abnormal flight procedure 216. In this manner, the sending of alert 232 by alert generator 212 enables action 236 to be taken in a manner that enhances safety. As depicted, action 236 may be taken by a person, such as air traffic controller 238 for airport 220.

As depicted, air traffic control system 234 is a hardware system that may include software. Air traffic control system 234 may be comprised of various physical devices. For example, air traffic control system 234 may include one or more data processing systems selected from at least one of a computer, a desktop computer, a workstation, a laptop computer, a tablet computer, a mobile phone, or some other suitable data processing system.

In this example, alert generator 212 sends alert 232 to air traffic control system 234 through communications transmitter 240 in electronic devices 206. In this illustrative example, communications transmitter 240 is selected from one of a controller-pilot data link communications (CPDLC) transmitter, a satellite communications (SATCOM) transmitter, or some other suitable type of communications device.

Alert generator 212 is a component in computer system 204 that may be implemented in software, hardware, firmware, or a combination thereof. When software is used, the operations performed by alert generator 212 may be implemented in program code configured to run on hardware, such as a processor unit. When firmware is used, the operations performed by alert generator 212 may be implemented in program code and data and stored in persistent memory to run on a processor unit. When hardware is employed, the hardware may include circuits that operate to perform the operations in alert generator 212.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

Thus, computer system 204 with alert generator 212 forms a terminal alert system. Computer system 204 with alert generator 212 provides one or more technical solutions that solve the technical problem of providing information about abnormal flight procedures occurring within a terminal area of an airport quickly enough to enable operations to increase safety in the terminal area.

Alert generator 212 provides a technical solution in which alert 232 is sent when the group of signals 214 indicating abnormal flight procedure 216 is detected for aircraft 202. Alert 232 may be sent while pilot 242 performs other operations prior to communicating with air traffic controller 238. In this manner, air traffic controller 238 is aware of abnormal flight procedure 216 earlier as compared to currently used processes for reporting abnormal flight procedures. This technical solution enables enhancing safety for air traffic around airport 220.

Additionally, alert generator 212 also provides a technical solution in which information, such as flight information 244 in alert 232, is sent to air traffic control system 234. Flight information 244 provides air traffic controller 238 with an ability to have more information in addition to knowing that the planned procedure for aircraft 202 has been aborted. This additional information may enable performing action 236 in a manner that further enhances safety.

As a result, computer system 204 operates as a special purpose computer system in which alert generator 212 in computer system 204 enables quicker notification about abnormal flight procedures for aircraft in terminal area 218 of airport 220. In particular, alert generator 212 transforms computer system 204 into a special purpose computer system as compared to currently available general computer systems that do not have alert generator 212 to send alert 232.

Computer system 204 performs a transformation of data in the illustrative examples. For example, alert generator 212 in computer system 204 monitors the group of signals 214 indicating the presence of abnormal flight procedure 216. The group of signals 214 is transformed into alert 232 providing information that may be used by air traffic controller 238 at airport 220.

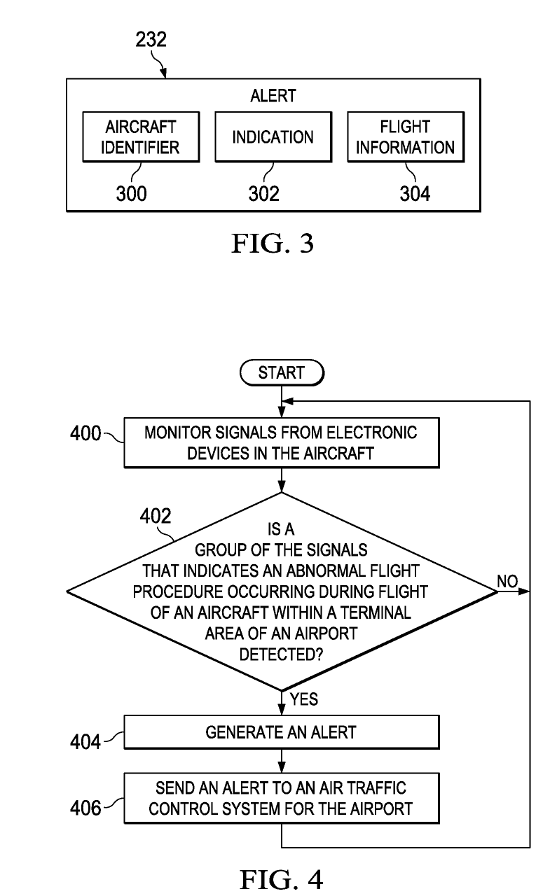

With reference to FIG. 3, an illustration of a block diagram of an alert is depicted in accordance with an illustrative embodiment. In this figure, an example of information that may be contained in alert 232 is shown. As depicted, information in alert 232 includes aircraft identifier 300, indication 302, and flight information 304.

In this illustrative example, aircraft identifier 300 identifies aircraft 202 in FIG. 2 sending alert 232. In this illustrative example, aircraft identifier 300 may take various forms. For example, aircraft identifier 300 may be selected from at least one of a tail number, a serial number, an alphanumeric string, or some other form that identifies aircraft 202.

As depicted, indication 302 identifies alert 232 as a message about an abnormal procedure. Indication 302 may take various forms. For example, indication 302 may be an alphanumeric code, a word, a phrase, or some other suitable type of indication.

In the depicted example, flight information 304 includes additional information about aircraft 202. For example, flight information 304 may include information selected from at least one of a depression of a takeoff-go-around button, an emergency procedure performed, a warning message, a route discrepancy, an altitude discrepancy, a location of the aircraft, a change in a direction of travel of the aircraft, a change in thrust, an airspeed beyond a predetermined threshold speed, a landing gear configuration, a flap configuration, or other suitable information about aircraft 202.

The illustration of airport environment 100 and the different components in FIGS. 2-3 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, communications transmitter 240 may be implemented as part of a transceiver rather than just a stand-alone transmitter. In yet another illustrative example, the communications medium used by data bus 210 may include wireless communications links, wired communications links, optical fiber links, or some combination thereof. Further, data bus 210 also may take the form of a network in which routers, switches, and other network devices are present in aircraft 202.

Turning next to FIG. 4, an illustration of a flowchart of a process for handling the occurrence of an abnormal procedure is depicted in accordance with an illustrative embodiment. The process illustrated in FIG. 4 may be implemented in computer system 204 and aircraft 202 in FIG. 2. For example, the process may be implemented in alert generator 212 in computer system 204 in FIG. 2.

The process begins by monitoring signals from electronic devices in the aircraft (operation 400). A determination is made as to whether a group of the signals is detected that indicates an abnormal flight procedure occurring during flight of an aircraft within a terminal area of an airport (operation 402). In this illustrative example, the signal may be detected in flight during one of a landing of the aircraft and a takeoff of the aircraft.

If a signal indicating the occurrence of an abnormal flight procedure is detected, the process generates an alert (operation 404). The alert may include information about the aircraft. In generating the alert, the process may include the types of information shown for alert 232 in FIG. 3.

The process then sends an alert to an air traffic control system for the airport (operation 406). The process then returns to operation 400 to monitor for another group of signals indicating the occurrence of another abnormal flight procedure.

With reference again to operation 402, if a group of signals indicating an abnormal flight procedure is not detected, the process also returns to operation 400. In this manner, the process enables an action that enhances safety. For example, the air traffic controller may perform one or more actions with respect to the aircraft generating the alert or other aircraft to increase safety margins for aircraft operating in the terminal space around the airport.

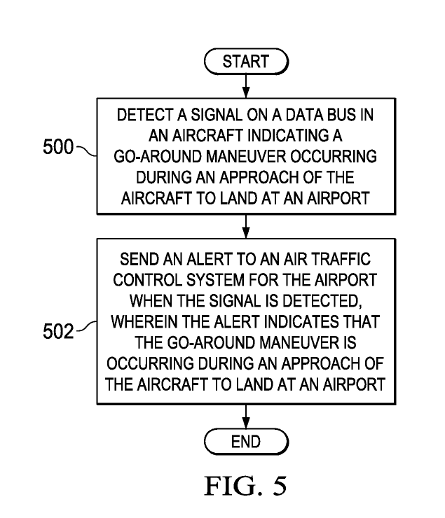

With reference now to FIG. 5, an illustration of a flowchart of a process for reporting a missed approach is depicted in accordance with an illustrative embodiment. The process illustrated in FIG. 5 may be implemented in alert generator 212 in computer system 204 in FIG. 2.

The process begins by detecting a signal on a data bus in an aircraft indicating a go-around maneuver occurring during an approach of the aircraft to land at an airport (operation 500). In this illustrative example the signal may be detected during one of a landing of the aircraft and a takeoff of the aircraft.

The process sends an alert to an air traffic control system for the airport when the signal is detected, wherein the alert indicates that the go-around maneuver is occurring during an approach of the aircraft to land at an airport (operation 502) with the process terminating thereafter. In this manner, the process in FIG. 5 may enable rerouting of air traffic in a manner that enhances safety.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

For example, an operation may be included to let the pilot know that an alert has been sent to the air traffic control system for the air traffic controller. In another example, the alert and information in the alert may be stored in a log for later review. Also, details of the abnormal procedure may be recorded and logged for later review.

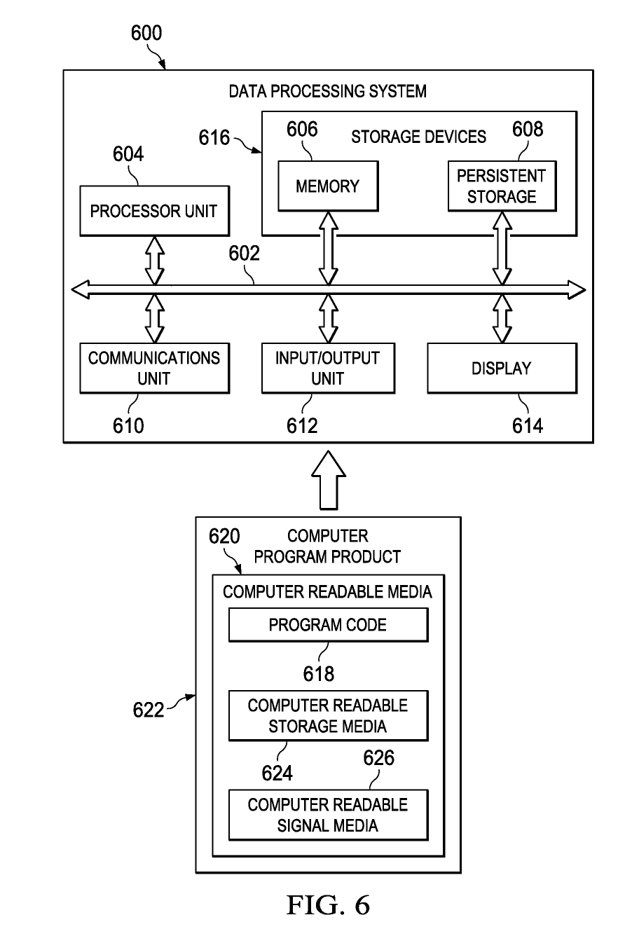

Turning now to FIG. 6, an illustration of a block diagram of a data processing system is depicted in accordance with an illustrative embodiment. Data processing system 600 may be used to implement a data processing system in computer system 204, electronic devices 206, and air traffic control system 234. In this illustrative example, data processing system 600 includes communications framework 602, which provides communications between processor unit 604, memory 606, persistent storage 608, communications unit 610, input/output (I/O) unit 612, and display 614. In this example, communications framework 602 may take the form of a bus system.

Processor unit 604 serves to execute instructions for software that may be loaded into memory 606. Processor unit 604 may be a number of processors, a multi-processor core, or some other type of processor, depending on the particular implementation.

Memory 606 and persistent storage 608 are examples of storage devices 616. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 616 may also be referred to as computer readable storage devices in these illustrative examples. Memory 606, in these examples, may be, for example, a random access memory or any other suitable volatile or non-volatile storage device. Persistent storage 608 may take various forms, depending on the particular implementation.

For example, persistent storage 608 may contain one or more components or devices. For example, persistent storage 608 may be a hard drive, a flash memory, a rewritable optical disk, a rewritable magnetic tape, or some combination of the above. The media used by persistent storage 608 also may be removable. For example, a removable hard drive may be used for persistent storage 608.

Communications unit 610, in these illustrative examples, provides for communications with other data processing systems or devices. In these illustrative examples, communications unit 610 is a network interface card.

Input/output unit 612 allows for input and output of data with other devices that may be connected to data processing system 600. For example, input/output unit 612 may provide a connection for user input through at least of a keyboard, a mouse, or some other suitable input device. Further, input/output unit 612 may send output to a printer. Display 614 provides a mechanism to display information to a user.

Instructions for at least one of the operating system, applications, or programs may be located in storage devices 616, which are in communication with processor unit 604 through communications framework 602. The processes of the different embodiments may be performed by processor unit 604 using computer-implemented instructions, which may be located in a memory, such as memory 606.

These instructions are referred to as program code, computer usable program code, or computer readable program code that may be read and executed by a processor in processor unit 604. The program code in the different embodiments may be embodied on different physical or computer readable storage media, such as memory 606 or persistent storage 608.

Program code 618 is located in a functional form on computer readable media 620 that is selectively removable and may be loaded onto or transferred to data processing system 600 for execution by processor unit 604. Program code 618 and computer readable media 620 form computer program product 622 in these illustrative examples. In one example, computer readable media 620 may be computer readable storage media 624 or computer readable signal media 626. In these illustrative examples, computer readable storage media 624 is a physical or tangible storage device used to store program code 618 rather than a medium that propagates or transmits program code 618.

Alternatively, program code 618 may be transferred to data processing system 600 using computer readable signal media 626. Computer readable signal media 626 may be, for example, a propagated data signal containing program code 618. For example, computer readable signal media 626 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 600 are not meant to provide architectural limitations to the manner in which different embodiments may be implemented. The different illustrative embodiments may be implemented in a data processing system including components in addition to or in place of those illustrated for data processing system 600. Other components shown in FIG. 6 can be varied from the illustrative examples shown. The different embodiments may be implemented using any hardware device or system capable of running program code 618.

Thus, the illustrative embodiments provide a method and apparatus for handling an occurrence of an abnormal procedure during flight of an aircraft in the terminal area of an airport. In the illustrative examples, abnormal procedures, such as a missed approach during landing or deviating from the path for takeoff, are reported to an air traffic control system in a manner that alerts an air traffic controller of the abnormal procedure faster than currently used processes in which the pilot communicates with the air traffic controller.

Additionally, the alert generator may also include information about the aircraft that may aid the air traffic controller in enhancing air safety. In this manner, the air traffic controller may perform an action with respect to the aircraft generating the alert or other aircraft in the terminal area to increase safety margins.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

1. A system for reporting a missed approach by an aircraft, the system comprising:
a communications interface to a data bus in the aircraft; and
a computer system in communication with the communications interface, wherein the computer system operates to detect a group of signals on the data bus that indicates a go-around maneuver occurring during an approach of the aircraft to land at an airport, and sends an alert to an air traffic control system for the airport when the group of signals is detected, wherein the alert indicates an occurrence of the go-around maneuver, enabling rerouting of air traffic in a manner that enhances safety.

2. The system of claim 1, wherein the group of signals on the data bus indicates at least one of an initiation of the go-around maneuver, a change in altitude indicating the go-around maneuver, a command to increase engine power for the go-around maneuver, or an increase in engine power indicative of the go-around maneuver.

3. The system of claim 1, wherein the group of signals on the data bus indicates at least one of an initiation of a retraction of a landing gear during the approach, a depression of a takeoff-go-around button, advancing of a throttle that is more than expected for landing, an increase in a speed that is more than expected for landing, or taking flaps up during the approach.

4. The system of claim 1, wherein the alert comprises:
information selected from at least one of a depression of a takeoff-go-around button, an emergency procedure performed, a warning message, a route discrepancy, an altitude discrepancy, a location of the aircraft, a change in a direction of travel of the aircraft, a change in a thrust, an airspeed beyond a predetermined threshold speed, a landing gear configuration, or a flap configuration.

5. The system of claim 1 further comprising:
a communications transmitter, wherein the computer system sends the alert to the air traffic control system using the communications transmitter.

6. The system of claim 5, wherein the communications transmitter is selected from one of a controller-pilot data link communications transmitter and a satellite communications transmitter.

7. The system of claim 1, wherein the computer system is selected from at least one of a computer, a flight management system, an electronic flight bag, a tablet computer, a mobile phone, or a laptop computer.

8. The system of claim 1, wherein the air traffic control system is selected from at least one of a computer, a desktop computer, a workstation, a laptop computer, a tablet computer, or a mobile phone.

9. An apparatus comprising:
a computer system for an aircraft, wherein the computer system detects a group of signals in the aircraft indicating an abnormal flight procedure occurring during flight of the aircraft within a terminal area of an airport and sends an alert to an air traffic control system for the airport indicating an occurrence of the abnormal flight procedure, enabling an action that enhances safety.

10. The apparatus of claim 9, wherein the group of signals indicating the abnormal flight procedure indicates at least one of an initiation of a go-around maneuver, a retraction of landing gear during an approach, a change in altitude indicating the go-around maneuver, a command to increase engine power for the go-around maneuver, a deviation from a landing pattern, a deviation from a takeoff pattern, or a depression of a takeoff-go-around button.

11. The apparatus of claim 9, wherein the alert comprises:
information selected from at least one of a depression of a takeoff-go-around button, an emergency procedure performed, a route discrepancy, an altitude discrepancy, a location of the aircraft, a change in a direction of travel of the aircraft, a change in a thrust, an airspeed beyond a predetermined threshold speed, a landing gear configuration, or a flap configuration.

12. The apparatus of claim 9, wherein the group of signals is detected during one of a landing of the aircraft and a takeoff of the aircraft.

13. The apparatus of claim 9 further comprising:
a communications transmitter, wherein the computer system sends the alert to the air traffic control system using the communications transmitter.

14. The apparatus of claim 13, wherein the communications transmitter is selected from one of a controller-pilot data link communications transmitter and a satellite communications transmitter.

15. The apparatus of claim 9, wherein the computer system is selected from at least one of a computer, a flight management system, an electronic flight bag, a tablet computer, a mobile phone, or a laptop computer.

16. The apparatus of claim 9, wherein the air traffic control system is selected from at least one of a computer, a desktop computer, a workstation, a laptop computer, a tablet computer, or a mobile phone.

17. A method for handling a missed approach of an aircraft, the method comprising:
detecting a group of signals on a data bus in the aircraft that indicates a go-around maneuver occurring during an approach of the aircraft to land at an airport; and
sending an alert to an air traffic control system for the airport when the group of signals is detected, wherein the alert indicates an occurrence of the go-around maneuver, enabling rerouting of air traffic in a manner that enhances safety.

18. The method of claim 17, wherein the group of signals on the data bus indicates at least one of an initiation of the go-around maneuver, a change in altitude indicating the go-around maneuver, a command to increase engine power for the go-around maneuver, or an increase in engine power indicative of the go-around maneuver.

19. The method of claim 17, wherein the group of signals on the data bus indicates at least one of an initiation of a retraction of a landing gear during the approach or a depression of a takeoff-go-around button.

20. The method of claim 17, wherein the alert comprises:
information selected from at least one of an indication of a depression of a takeoff-go-around button, an emergency procedure performed, a route discrepancy, an altitude discrepancy, a location of the aircraft, a change in a direction of travel of the aircraft, a change in a thrust, an airspeed beyond a predetermined threshold speed, a landing gear configuration, or a flap configuration.

21. The method of claim 17 further comprising:
rerouting the air traffic in the manner that enhances the safety.

22. The method of claim 17 further comprising:
changing a takeoff clearance for another aircraft on a runway at the airport based on the alert.

23. The method of claim 17, wherein detecting a group of signals and sending an alert are performed by a computer system selected from at least one of a flight management system, an electronic flight bag, a tablet computer, a mobile phone, or a laptop computer.
